(19) United States
(12) Patent Application Publication
(10) Pub. No.: US 2026/0016311 A1
(43) Pub. Date: Jan. 15, 2026

(54) DESTINATION PREVISUALIZATION

(71) Applicant: GM Global Technology Operations LLC, Detroit, MI (US)

(72) Inventors: Kiran Babu, Detroit, MI (US); Jacob Alan Bond, Rochester Hills, MI (US); Pallavi Gautam, Royal Oak, MI (US); Joseph F. Szczerba, Grand Blanc, MI (US)

(21) Appl. No.: 18/769,766

(22) Filed: Jul. 11, 2024

(51) Int. Cl. G01C 21/36

(52) U.S. Cl. CPC G01C 21/3605; G01C 21/3664

(57) ABSTRACT

A method for previsualizing a destination includes receiving, at a controller, a destination from a user. The controller retrieves a set of stored destination preferences and at least one image of the received destination. A route is generated to the received destination. A previsualization image of at least a portion of the route is generated and displayed to a user. The route is implemented using the controller in response to the user accepting the route.

### INTRODUCTION

The subject disclosure relates to vehicles, and in particular to routing systems and processes for a vehicle.

Vehicle navigation systems plan, and in the case of automated vehicles, implement routes to travel from a point of origin to a destination using global positioning systems (GPS) and/or similar satellite based navigation. In some cases, a passenger may have certain post vehicle requirements (e.g. handicap accessibility) which may impact their decision to utilize the automatically planned route.

Furthermore, with regards to certain types of accessibility, varying conditions at the destination may impact whether an individual is able to travel to the destination. By way of example, snow or ice on an accessibility ramp may impede someone from entering a building at their destination rendering the purpose of the trip moot. Similarly, a destination may be described as “accessible” but lack particular accessibility features required by a give user.

Accordingly, it is desirable to provide vehicle operators and passengers additional information regarding accessibility at a destination and providing the operator and passengers an opportunity to alter or cancel a trip based on the additional information.

### SUMMARY

In one exemplary embodiment a method for previsualizing a destination includes receiving, at a controller, a destination from a user. The controller retrieves a set of stored route preferences and at least one image of the received destination. A route is generated to the received destination. A previsualization image of at least a portion of the route is generated and displayed to a user. The route is implemented using the controller in response to the user accepting the route after viewing the previsualization image.

In addition to one or more of the features described herein wherein receiving the destination from the user further includes receiving at least one additional destination preference from the user.

In addition to one or more of the features described herein the at least one image of the received destination includes a static image of a recent state of an end point of the route.

In addition to one or more of the features described herein the at least one image of the received destination includes a real time video feed including an end point of the route.

In addition to one or more of the features described herein the previsualization image is continuously updated as the route is implemented.

In addition to one or more of the features described herein the method includes identifying, using the controller, a change in a state of the end point of the destination based on a change in the at least one image of the received destination and notifying the user of the change.

In addition to one or more of the features described herein the method includes altering the previsualization image based on the change in the at least one image of the received destination.

In addition to one or more of the features described herein the previsualization image includes multiple routing instructions for reaching the destination subsequent to departing the vehicle.

In addition to one or more of the features described herein the method further includes transferring the previsualization image to a connected mobile device subsequent to departing the vehicle.

In addition to one or more of the features described herein the set of stored destination preferences includes a set of mandatory preferences and a set of preferred preferences, and wherein the generated route includes all the mandatory preferences.

In addition to one or more of the features described herein each preference in the set of preferred preferences includes a weight and wherein the weight corresponds to an importance of the preference.

In another exemplary embodiment a previsualization architecture for a vehicle includes a controller having a route navigation module and a previsualization module. A preferences database is in communication with the route navigation module. A screen is in communication with the controller, such that the controller controls a displayed image on the screen. An image database, a mobile device, and at least one infrastructure camera are in communication with the controller. The controller is configured to implement a method of receiving, at the controller, a destination from a user, retrieving, using the controller, a set of stored destination preferences, retrieving at least one image of the received destination, generating a route to the received destination, generating a previsualization image of at least a portion of the route and displaying the previsualization image to the user, and implementing the route using the controller in response to the user accepting the route.

In addition to one or more of the features described herein the screen is a touchscreen interface.

In addition to one or more of the features described herein, the previsualization architecture includes at least one user input device associated with the screen.

In addition to one or more of the features described herein the controller is a vehicle controller.

In addition to one or more of the features described herein the image database is remote from the vehicle.

In addition to one or more of the features described herein the at least one infrastructure camera includes a network of infrastructure cameras including a view of the end point of the route.

In addition to one or more of the features described herein, the previsualization architecture includes a mobile device in communication with the controller and wherein the controller is configured to transferring the previsualization image to a connected mobile device subsequent to departing the vehicle.

In addition to one or more of the features described herein the controller is configured to update the previsualization image as the route is implemented and to identify a change in the end point of the destination based on a change in the at least one image of the received destination and notifying the user of the change.

In yet another exemplary embodiment A vehicle includes a previsualization architecture having a controller having a route navigation module and a previsualization module, a preferences database in communication with the route navigation module, a screen in communication with the controller, such that the controller controls a displayed image on the screen, an image database, a mobile device, and at least one infrastructure camera in communication with the controller. The controller is configured to implement a method of receiving, at the controller, a destination from a user, retrieving, using the controller, a set of stored destination preferences, retrieving at least one image of the received destination, generating a route to the received destination, generating a previsualization image of at least a portion of of the route and displaying the previsualization image to the user, and implementing the route using the controller in response to the user accepting the.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an exemplary vehicle including a route previsualization system;

FIG. 2 is an exemplary system architecture for a previsualization system, such as the previsualization system of FIG. 1, including physical components and software modules;

FIG. 3 is an exemplary process for using the previsualization system of FIG. 2;

FIG. 4. is an example previsualization image generated by the previsualization system of FIG. 2.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term controller refers to dedicated controllers including a processor and a memory, general controllers including one or more processors and memory storing specialized instructions for implementing or partially implementing a control process, distributed control systems including multiple individual controllers, each of which includes a processor and a memory and each of which is configured to operate in conjunction with one or more other of the multiple individual controllers to achieve a shared control operation, as well as any similar control based configuration.

As used herein the term “cloud computing” refers to processing and computational systems distributed across multiple interconnected computers. The interconnection can be via direct wired communication, direct wireless communication, indirect communication through one or more intermediary systems, or any combination thereof.

As used herein, “cloud” refers to a network of interconnected devices and systems configured to operate a cloud computing system. The cloud may include controllers, personal computers, mobile devices, cellular network infrastructure, and/or any similar devices.

In accordance with an exemplary embodiment a vehicle route planning feature includes a previsualization system that generates an image showing real time conditions at a destination. The previsualization is generated as part of a route planning process, thereby allowing a vehicle operator or passenger (referred to generally as “user(s)”) to verify that the conditions at the destination are acceptable. In some examples, the previsualization can include additional routing for a passenger after exiting the vehicle further identifying accessible paths. In these examples, the previsualization system is configured to transfer the post arrival routing to a corresponding mobile device, thereby allowing the user to continue following the routing after arrival.

Implementation of the previsualization system allows users with access limitations to see the conditions of their destination prior to beginning the trip, thereby allowing the users to alter or cancel the trip without requiring them to travel to the destination itself. In addition, some implementations can further benefit the user by accounting for preferences (e.g. preferred grade of an accessibility ramp, a preferred maximum number of stair steps) and automatically adjusting the route to accommodate the preferences, while still planning routes that do not meet the preferences when such is unavoidable.

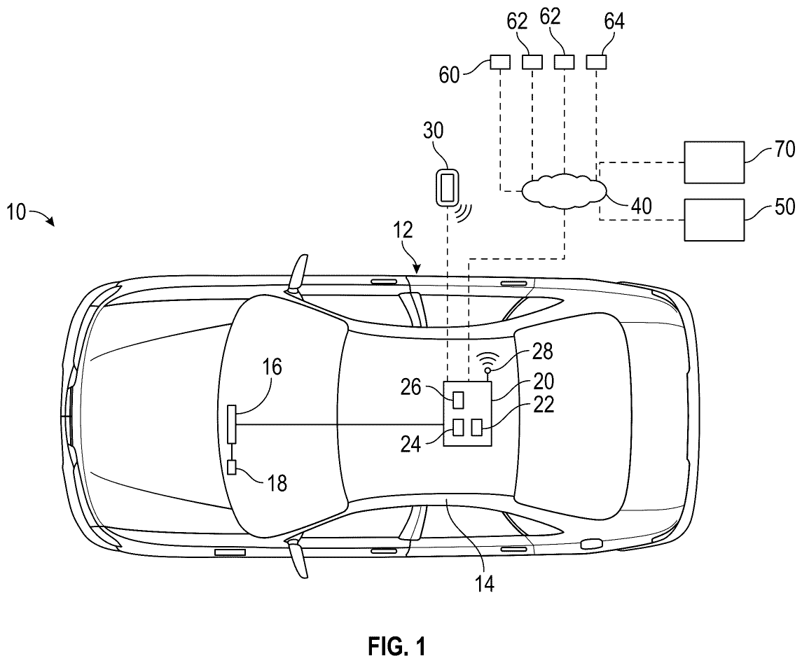

With reference to the general system described above, FIG. 1 illustrates an exemplary vehicle 10 including a body 12 and a passenger compartment 14. A screen 16, such as an infotainment display, instrumentation display, or similar screen is positioned in the passenger compartment and is viewable by occupants of the passenger compartment 14. The screen 16 is, in some examples, a touchscreen allowing prompts to be displayed and/or otherwise interacted with thereby allowing occupants of the passenger compartment 14 to provide feedback and interact with prompts. In such examples, the screen 16 itself is an input device. In other examples, the screen 16 is paired with one or more associated input devices (user interfaces 18), allowing a vehicle operator or passenger to interact with prompts and displays on the screen 16. The user interfaces 18 may be directly integrated into the screen 16 or separate from, but in communication with the screen 16.

The screen 16 is in communication with a controller 20, such that the controller 20 controls what is displayed on the screen 16 and the controller 20 can receive and act on information provided through the screen 16 and any associated user interfaces 18. The controller 20 includes a route navigation module 22, a previsualization module 24, and a preferences database 26.

The controller 20 includes a wireless communication system 28. The wireless communication system 28 allows the controller 20 to interface with one or more remote devices 30 of a user. In addition, the wireless device is able to communicate through a cloud 40 with one or more image databases 50, as well as any number of additional previsualization systems 60, infrastructure devices 62, vehicles 64 including vehicle to vehicle (V2V) communications, and other sources of up to date information regarding a state of the destination. In some examples the image database 50 contains static images of destinations. In alternate examples, the image database 50 includes video feed able to provide a dynamic representation of some or all of the destination. By way of example, the infrastructure devices 62 can include intersection cameras, security cameras, satellite data, vehicle to infrastructure (VtoX) data, construction cameras, and closed circuit television cameras. Also connected through the cloud 40 is a weather database 70. The weather database 70 can include current and historical weather data, allowing for the previsualization system to account for current and recent weather events in the visualization.

In addition, any number of other similar databases and/or database groups may be connected to the controller 20 through the cloud 40 and provide relevant information for the previsualization module 24.

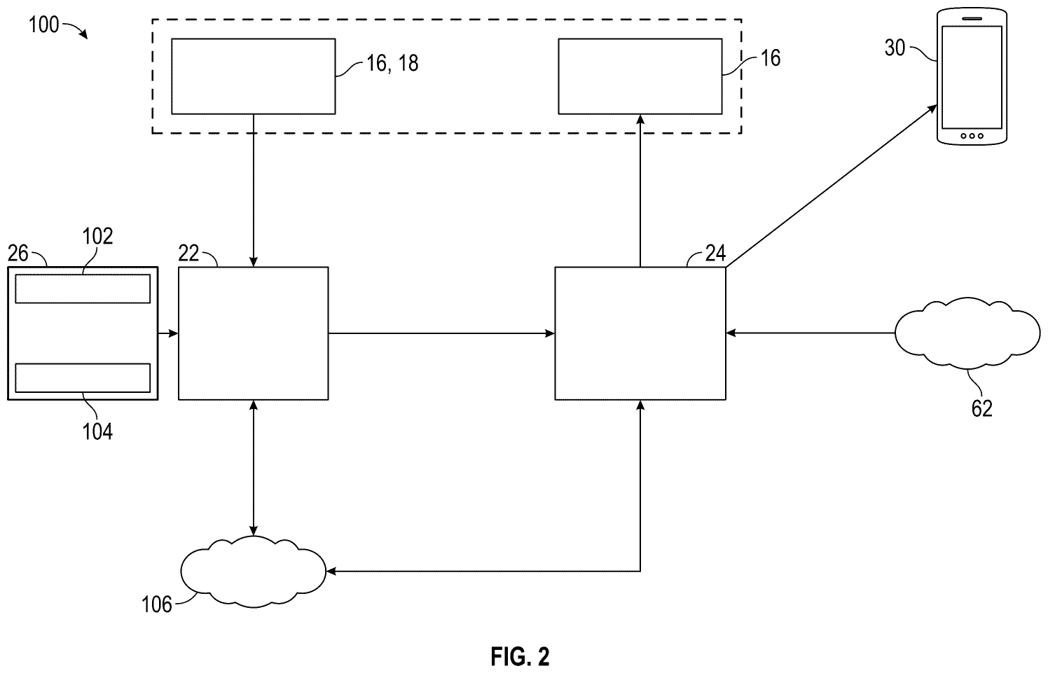

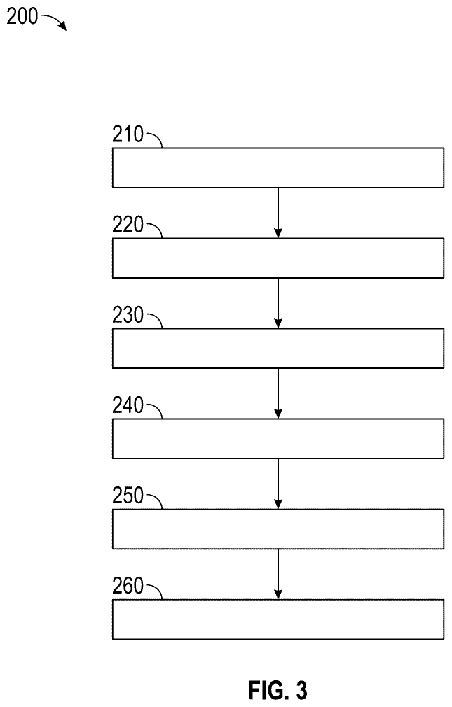

With continued reference to FIG. 1, FIG. 2 illustrates a system architecture 100 for operating a previsualization system in the vehicle 10, and FIG. 3 illustrates a process 200 for using the system architecture 100 of FIG. 2. The system architecture 100 includes physical components and software modules which operate in conjunction to generate a previsualization of a destination during a route planning process.

The process 200 begins with the route navigation system 22 receiving a destination in a Receive Destination step 210. The destination is provided to the route navigation system 22 through the user interface 18 or the screen 16. In some examples, the operator of the system architecture 100 can use the user interface 18 or the screen 16 to provide one or more route-specific preferences simultaneous with the destination. The route specific preferences are preferences that apply to a specific trip and should not be retained for all future trips. In one example, a route specific preference may include a requirement that the route be limited to calm traffic due to fragile cargo. In another example, the route specific preference may include a requirement that the destination include a deviation from the typical grade of an accessibility ramp (shallower or steeper). In yet another example, the route-specific preferences may include avoiding construction zones and other route deviations, avoiding one way streets, restricting travel areas based on an amount of light in the travel area, avoiding high pedestrian activity zones (e.g. school zones), avoiding high risk zones, and avoiding large elevation changes.

After the destination and route specific preferences have been received, the route navigation system 22 accesses a preferences database 26 to retrieve any stored accessibility preferences in a Retrieve Preferences step 220. The stored preferences database 26 can include two sets of data, a requirements set 102 and a preferences set 104. In some examples, the stored preferences database 26 may be limited to only the requirements set 102.

The requirements set 102 is a set of user preferences that are mandatory in order for a route to be successfully implemented. By way of example, for an individual requiring certain mobility aids (e.g. a wheel chair), one requirement may be a useable accessibility ramp. In contrast, the preferences set 104 are preferences that are not mandatory but are desired. By way of example, individuals utilizing crutches or a cane for assisted walking may have a preference that the end destination includes less than a desired number of stair steps. In this case the operator is able to navigate the steps, however such navigation is difficult. Each preference in the preferences set 104 is assigned a weight (e.g. a percentage) with the weight impacting how strong the preference is. In this format, a requirement in the requirements set 102 is given the maximum weight (e.g. 100%). The route navigation system 22 applies the preference and the weight in determining potential routes, as well as potential ending points for a single destination.

In addition to retrieving the preferences, the route navigation system 22 accesses any available information regarding the destination through the cloud 40 in a Retrieve Destination Images step 230. The destination images can be pulled from any number of sources included dedicated image databases 106, web crawls via search engine searching, databases of infrastructure 62 including cameras having a view of the destination, and any similar sources. The images and any other available information regarding the accessibility of the destination are provided to the route navigation system 22 and the previsualization system 24.

The route navigation system 22 then determines whether the route to the destination meets any required preferences and, if so, generates a route to the destination in a Generate Route step 240. The generated route, as well as the preferences, and any obtained image data, is passed to the previsualization system 24 and a previsualization of the end destination is generated and displayed by the previsualization system 24 in a Display Destination Previsualization step 250.

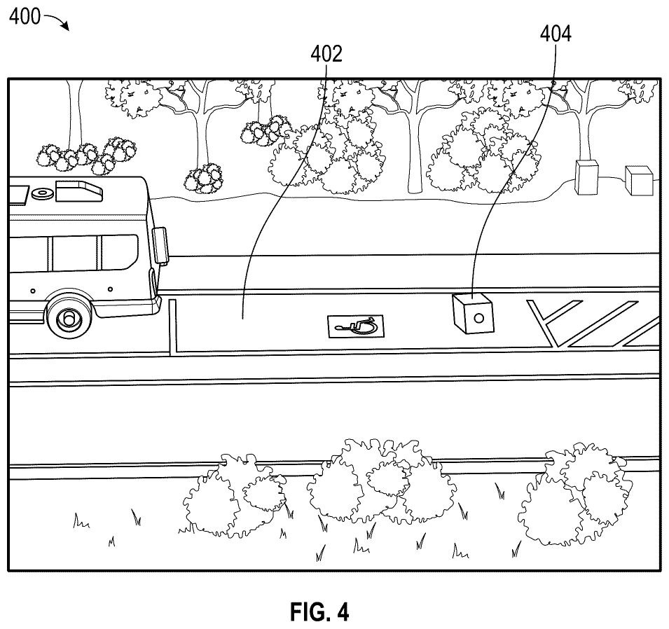

The previsualization system 24 utilizes a combination of real time images and data feeds to generate an image representative of the current state of the destination and to display the image on the screen 16. With continuing reference to FIGS. 1-3, FIG. 4 illustrates an example previsualization 400 generated by the previsualization system. While the destination includes an open handicap parking spot 402, a waste bin 404 is currently placed within the handicap parking spot 402, rendering the handicap parking spot 402 unusable. The previsualization allows the user to see the current state (blocked) of the destination and make a determination as to whether the trip should be made. In instances where multiple possible destinations (e.g. multiple available handicap parking spots exist), the previsualization allows the user to compare the current state of each possible destination and select the destination whose current state best suites the users needs. In yet further implementations the multiple possible destinations may be compared by the route navigation system and one or more of the possible destinations may be discarded as unsuitable (e.g. a fully blocked handicap parking spot) without presentation to the user.

It is appreciated that the previsualization can likewise include computer generated elements overlaying the retrieved image, with the computer generated elements conveying additional information provided by, or derived from, the infrastructure devices 62, cloud connected databases and the like. In one example, a step count indicating the number of stair steps that must be taken could be displayed. In another example, an expected weather event (e.g. incoming snow storm) may be displayed.

In some examples, the previsualization system 24 includes an extrapolation process that allows the previsualization system 24 to extrapolate from a current real time image 400, thereby allowing non-visible objects or elements to be included in the previsualization image 400. The extrapolation can be a simple rules based extrapolation stored in the controller 20 or a machine learning based image extrapolation including cloud based processing, with the machine learning based image extrapolation allowing the image to be rotated, extended, and/or any similar image manipulation. Similarly the previsualization system 24 may use existing image manipulation processes to merge, or otherwise combine multiple images of the destination to create a single image that can be rotated scanned or paned by the user.

In the case where image manipulation is enabled, the input 18 or the screen 16 allow the user to manually rotate, shift zoom, or any similar manipulations to provide a better visualization of the destination features that are relevant to their preferences.

After presenting the user with the previsualization image 400, the previsualization system 24 requests approval to begin the route in a Request Route Approval step 260. The route approval can be communicated via the user interface 18 or the screen 16.

In some examples, the previsualization image 400 can include additional steps and/or routing information beyond a parking location of the vehicle 10. Such information is useful for the operator to have access to after the user has exited the vehicle. In order to accommodate these situations, the previsualization system includes an export feature. Once a destination is reached, the user or operator has the option, via the inputs 16,18 to export the previsualization to the mobile device 30 and continue viewing and manipulating the previsualization image 400 after exiting the vehicle 10.

In some examples, the previsualization system 24 can be continuously updated as the vehicle 10 travels along the determined route. The updates can be periodic or in real time. In some examples, the previsualization system 24 monitors for changes in the destination that would impact one or more of the users preferences. When an aspect changes (e.g., handicap parking spot 402 becoming occupied) the information can be pushed to the user via the screen 16 and/or the mobile device 30. In some examples, the push notification is accompanied by a prompt allowing the user to compare the changes and alter or cancel the trip based on the changed status.

The continuous updating can be in the form of maintained communication with one or more infrastructure systems 62, a vehicle to vehicle and/or vehicle to infrastructure system, or any similar communication between controller 20 and one or more remote system 62.

While described above within the general context of mobility impairment and accessibility, it is appreciated that the use of user preferences in creating a previsualization and determining the route can be beneficial in alternative vehicle uses as well. By way of example, if a user wishes to travel to a large venue that has multiple entryways (e.g. a park, a concert, or a convention center) the user may utilize the previsualization to view a real time representation of each of the multiple entryways, thereby allowing the user to select with entryway best meets their preferences. These preferences can include accessibility, a preference to walk farther rather than enter a larger crowd, a preference for certain facilities to be within a distance of the destination (e.g., restrooms). In addition the preferences and requirements may be used by the route navigation module 22 to suggest a best fit end point for the route. In yet further examples, where there are multiple potential endpoints, the previsualization system may automatically suggest the best potential endpoint factoring in user preferences.

In yet further examples, the previsualization system 24 can include motion and/or voice command interpretation connected to one or more camera or audio capture devices facing the passenger compartment 14.

In some implementations of the process 200 of FIG. 3, the controller can prompt the user to provide feedback on the accuracy of the data at the destination. By way of example, the user could provide feedback identifying that an accessibility ramp is in disrepair, is too steep to use, is permanently obstructed, or the like. In such examples, the feedback is aggregated by the controller and can be stored in the preferences database, or communicated to a central database via the cloud 40. When communicated to a central database, the feedback can be further transmitted to other vehicles, allowing for all vehicles 10 equipped with the previsualization system 24 to receive updated information regarding a current status of the destination.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for previsualizing a destination comprising:
receiving, at a controller, a destination from a user;
retrieving, using the controller, a set of stored route preferences;
retrieving at least one image of the received destination;
generating a route to the received destination;
generating a previsualization image of at least a portion of the route and displaying the previsualization image to the user; and
implementing the route using the controller in response to the user accepting the route.

2. The method of claim 1, wherein receiving the destination from the user further includes receiving at least one additional destination preference from the user.

3. The method of claim 1, wherein the at least one image of the received destination includes a static image of a recent state of the at least the portion of the route.

4. The method of claim 1, wherein the at least one image of the received destination includes a real time video feed including the at least the portion of the route.

5. The method of claim 1, wherein the previsualization image is continuously updated as the route is implemented.

6. The method of claim 5, further comprising identifying, using the controller, a change in a state of the destination based on a change in the at least one image of the received destination and notifying the user of the change.

7. The method of claim 6, further comprising altering the previsualization image based on the change in the at least one image of the received destination.

8. The method of claim 1, wherein the previsualization image includes multiple routing instructions for reaching the destination subsequent to departing the vehicle.

9. The method of claim 1, further comprising transferring the previsualization image to a connected mobile device subsequent to departing a vehicle.

10. The method of claim 1, wherein the set of stored destination preferences includes a set of mandatory preferences and a set of preferred preferences, and wherein the generated route includes all the mandatory preferences.

11. The method of claim 10, wherein each preference in the set of preferred preferences includes a weight and wherein the weight corresponds to an importance of the preference.

12. A previsualization architecture for a vehicle comprising:
a controller including a route navigation module and a previsualization module;
a preferences database in communication with the route navigation module;
a screen in communication with the controller, such that the controller controls a displayed image on the screen;
an image database, a mobile device, and at least one infrastructure camera in communication with the controller; and
wherein the controller is configured to implement a method of receiving, at the controller, a destination from a user, retrieving, using the controller, a set of stored destination preferences, retrieving at least one image of the received destination, generating a route to the received destination, generating a previsualization image of at least a portion of the route and displaying the previsualization image to the user, and implementing the route using the controller in response to the user accepting the route.

13. The previsualization architecture of claim 12, wherein the screen is a touchscreen interface.

14. The previsualization architecture of claim 12, further comprising at least one user input device associated with the screen.

15. The previsualization architecture of claim 12, wherein the controller is a vehicle controller.

16. The previsualization architecture of claim 15, wherein the image database is remote from the vehicle.

17. The previsualization architecture of claim 15, wherein the at least one infrastructure camera includes a network of infrastructure cameras including a view of an end point of the route.

18. The previsualization architecture of claim 12 further comprising a mobile device in communication with the controller and wherein the controller is configured to transferring the previsualization image to a connected mobile device subsequent to departing the vehicle.

19. The previsualization architecture of claim 12, wherein the controller is configured to update the previsualization image as the route is implemented and to identify a change in a state of the destination based on a change in the at least one image of the received destination and notifying the user of the change.

20. A vehicle comprising:
a previsualization architecture including a controller having a route navigation module and a previsualization module, a preferences database in communication with the route navigation module, a screen in communication with the controller, such that the controller controls a displayed image on the screen, an image database, a mobile device, and at least one infrastructure camera in communication with the controller; and
wherein the controller is configured to implement a method of receiving, at the controller, a destination from a user, retrieving, using the controller, a set of stored destination preferences, retrieving at least one image of the received destination, generating a route to the received destination, generating a previsualization image of an end point of the route and displaying the previsualization image to the user, and implementing the route using the controller in response to the user accepting the route.
